(19) United States
(12) Patent Application Publication
(10) Pub. No.: US 2005/0216896 A1
(43) Pub. Date: Sep. 29, 2005

(54) Data communication via tanslation map exchange

(75) Inventor: Almed Doleh, Sachse, TX (US)

Correspondence Address: HAYNES AND BOONE, LLP, 901 MAIN STREET, SUITE 3100, DALLAS, TX, 75202, US

(73) Assignee: Santera Systems, Inc., Plano, TX (US)

(21) Appl. No.: 10/809,963

(22) Filed: Mar. 26, 2004

(51) Int. Cl. G06F 9/45

(52) U.S. Cl. 717/136

(57) ABSTRACT

A method of exchanging data between first and second components having first and second native data structure formats, respectively. In one embodiment, the method includes exchanging native data structure format information between the first and second components, generating data in the first native data structure format, and transmitting the generated data between the first and second components. The generated data is translated into the second native data structure format based on the exchanged native data structure format information.

### BACKGROUND

Inter-operability and the ability to communicate between legacy and newer versions of software applications are required in many systems. For example, many redundant systems require consistency between active system data and standby (or “redundant”) system data, although the standby system may be populated with an older or newer version of the software in the active system. However, employing different software versions or applications within a system or network invariably leads to inconsistencies. For example, newer software versions may contain data structures that do not exist in older software versions. Additionally, even data structures that exist in both new and old software versions may contain different variables or fields. Properties of variables in data structures appearing in different software versions may also vary therebetween. Similar inconsistencies can also exist between data structures of different applications between which communication is desired.

At least in the case of upgrading legacy systems, such inconsistencies are often handled by patches or other types of special software having the operational behavior knowledge of the older system so that the revisions in the newer systems do not affect the older system. This is fairly easy to accomplish if the differences between the systems are small. However, as systems grow and additional features are added, the differences between legacy and upgraded systems become large and, in some cases, unmanageable.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of one embodiment of a processing system according to aspects of the present disclosure.

FIG. 2 is a flow-chart representing one embodiment of an initialization method according to aspects of the present disclosure.

FIG. 3 is a flow-chart representing one embodiment of a method for encoding and decoding messages according to aspects of the present disclosure.

FIG. 4 is a block diagram of one embodiment of at least a portion of a database that may be generated by a component of the system shown in FIG. 1.

FIG. 5 is a block diagram of another embodiment of at least a portion of a database that may be generated by a component of the system shown in FIG. 1.

FIG. 6 is a block diagram of one embodiment of at least a portion of a map that may be exchanged between components of the system shown in FIG. 1.

FIG. 7 is a block diagram of another embodiment of at least a portion of a map that may be exchanged between components of the system shown in FIG. 1.

### DETAILED DESCRIPTION

The present disclosure relates generally to electronic data sharing and, more specifically, to data communication between first and second applications having different native data structure formats.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

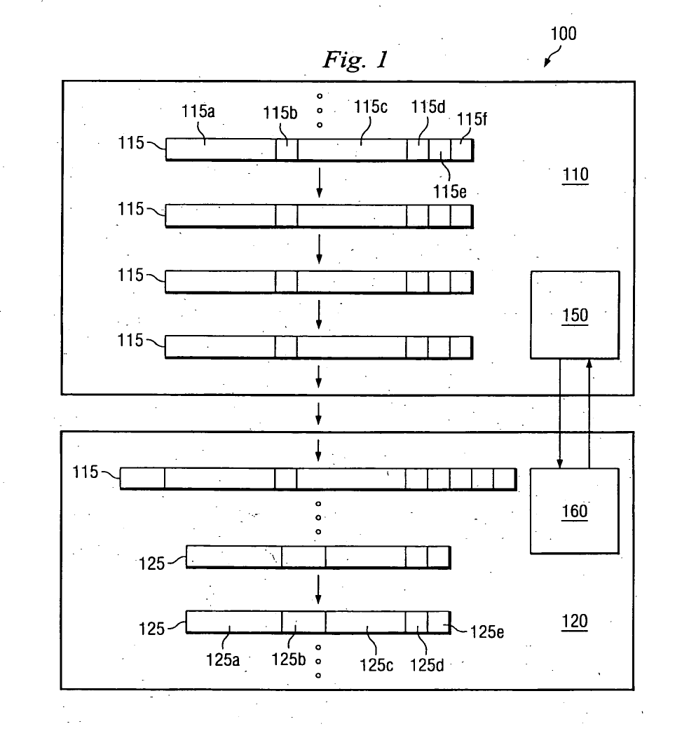

Referring to FIG. 1, illustrated is a schematic view of one embodiment of a system 100. The system 100 includes a component 110 operable to process data 115 having a native data structure format (NDSF). The system 100 also includes a second component 120 configured for processing data 125 having an NDSF that is different from the NDSF of the component 110. The system 100 may also include components in addition to the components 110, 120, and these additional components may also be operable to communicate with the components 110 and/or 120, and may each have an NDSF that is similar to or different from the NDSF of the components 110, 120.

For the sake of simplicity, the convention “NDSF data 115” employed herein contemplates data arranged according to the NDSF of the component 110, and “NDSF data 125” contemplates data arranged according to the NDSF of the component 120. Similar convention may also be employed herein with subsequently introduced NDSFs.

The component 110 is configured at least to transmit NDSF data 115, if not also data in other formats, to the component 120. The component 120 is configured at least to perform functions employing NDSF data 125 translated from NDSF data 115 and received from the component 110. The components 110, 120 may be or comprise primary and redundant components, or active and standby components, within a common system. For example, the components 110, 120 may be integral to or comprise primary and back-up servers employed with or in a networking switch. The components 110, 120 may also comprise different applications within a common system. For example, the component 110 may be integral to or comprise Microsoft WINDOWS (a product of Microsoft Corp. of Redmond, Wash.) and the component 120 may be integral to or comprise TURBO-TAX (a product of Intuit, Inc. of Mountain View, Calif.). The components 110, 120 need not be located in a common node of a system. For example, the components 110, 120 may be integral to or comprise different nodes of a network.

The NDSF data 115 and the NDSF data 125 have different data structure formats. For example, the NDSF data 115 may include six concatenated variables 115a-f having bit lengths of 6, 2, 6, 2, 2, 2, respectively, and the NDSF data 125 may include five concatenated variables 125a-e having bit lengths of 6, 3, 4, 2, 2, respectively. Thus, in the illustrated embodiment, the component 110 may perform functions with six variables, whereas the component 120 may perform related functions with five variables, and the NDSF data 115 variables and NDSF data 125 variables may have different sequences and lengths.

Of course, the present disclosure does not limit the size, type, or arrangement of bits or variables within a data structure or bundle native to the components 110, 120. For example, the data types of the variables 115a-f and/or 125a-e may be long integers, short integers, floating point numbers, characters, words, strings, concatenations, arrays, signed or unsigned, Boolean, and/or other types.

In one embodiment, the component 110 may bundle NDSF data 115 for transmission to the component 120, such that the component 120 may perform functions or operations with the data. However, because the NDSF data 115 is different from the NDSF data 125, the NDSF data 115 is translated into NDSF data 125. Although this translation may be performed by either of the components 110, 120, or a third component (not shown), in this example the component 120 performs the task of translation.

To facilitate the translation, the component 110 may transmit a translation map 150 to the component 120 with or after the transmission of the NDSF data 115. However, in one embodiment, the component 110 may repeatedly send the map 150 to the component 120 prior to sending each individual NDSF data 115 message or a group thereof. The component 110 may also send the map 150 to the component 120 prior to sending any NDSF data 115 to the component 120, such that the component 120 may then store the map 150 for use each time NDSF data 115 is subsequently received from the component 110. In one embodiment, the component 110 may send the map 150 to the component 120 substantially immediately after establishing a communication link with the component 110, such that the map 150 may be stored for use in subsequent translations of received NDSF data 115 until the communication link is broken, or even thereafter. In such an embodiment, the component 120 may also send a map 160 to the component 110 after the communication link is established, such that the component 110 may store the map 160 for use in subsequent translations of received NDSF data 125. The components 110, 120 may also exchange more translation maps of other components if the components 110, 120 are operable to send and process data in more than one NDSF. Each map 150, 160 may also include translation information for more than one NDSF.

Upon receipt of NDSF data 115, the component 120 may reference the map 150 (possibly in conjunction with the internal map 160) to translate the NDSF data 115 into NDSF data 125 for subsequent operations therewith. For example, in the illustrated embodiment, the component 120 employs five variables during a data processing operation but receives six variables in the NDSF data 115 from the component 110. Thus, information in the maps 150, 160 indicates to the component 120 that the first variable 125a that the component 120 needs to find in the NDSF data 115 corresponds to the variable 115a. Thus, the component 120 may store the value of the variable 115a for the variable 125a. The maps 150, 160 may also indicate that the variable 125b corresponds to the variable 115c. However, the variable 115c comprises six bits, whereas the variable 125b requires only three bits. Thus, the maps 150, 160 may also indicate which of the six bits in the variable 115c that the component 120 should store as the variable 125b. For example, the maps 150, 160 may indicate that the first three of the six bits in the variable 115c should be stored for the variable 125b, or that the last three of the six bits in the variable 115c should be stored. Thus, the maps 150, 160 may also indicate to the component 120 whether data is stored with the most-significant byte first or last, for example.

Continuing with the illustrated embodiment, the maps 150, 160 may also indicate to the component 120 that the variables 115e and 115f correspond to the variables 125d and 125e, and that the remaining variables (115b and 115d) in the NDSF data 115 do not correspond to any of the variables 125a-e. Thus, the variables 115b and 115d may be disregarded or discarded.

However, the maps 150, 160 have not indicated to the component 120 what to store from the NDSF data 115 for the variable 125c. Thus, the component 120 may call an initialization or other type of routine or function to populate the missing variable 125c with data required for subsequent operations. In one embodiment, the variables in the NDSF data 125 that do not correspond to variables in the NDSF data 115 may be populated with a default value, such as 0 or 1, which may be globally changed by a system or user. The component 120 may also include a user-interface by which a user may indicate a value to store or otherwise initialize these unpopulated variables, individually or by groups of variables. For example, the user may indicate that each unpopulated variable corresponding to a specific operation, application, function, class, object, or other common characteristic may have the same type and be populated with the same value.

Each of the maps 150, 160 include a global ID for each variable employed therein. In one embodiment, the global IDs may comprise a concatenation or combination, or may otherwise be based on, one or more characteristics of the corresponding variable. For example, each global ID may be based on the application from or for which a variable was created, the message or other data bundle in which the variable is transmitted, and an identification (name, number, etc.) of the variable within the message. In one embodiment, object-oriented programming (OOP) may be employed to design the translation of data communicated between the components 110, 120, in which case the global IDs may be based on one or more of a system, class, structure, message, object, element, etc., that creates, employs, or transmits the variable. For example, the global ID for the variable 115e may be “C1.M4.P5,” wherein “C1” may indicate that the variable 115e was originated or is employed in a particular class or component (such as component 110), “M4” may indicate the particular message or construct in which the variable is being transmitted, and “P5” may indicate the position of variable 115e within the message “M4.”

As described above, the components 110, 120 may exchange maps 150, 160 upon the establishment of a communication link. When the component 110 transmits NDSF data 115 to the component 120, the maps 150, 160 may be employed to compare the global IDs of the variables 115a-f and the variables 125a-e to determine how to populate the variables 125a-e with data transmitted by the variables 115a-f, default values, initialization values, or user-input values.

Each of the global IDs may also carry a descriptor of the corresponding variable. For example, the descriptor may indicate that the variable type is long integer, short integer, floating point, character, word, string, concatenation, array, signed or unsigned, Boolean, and/or other types. The descriptor may also indicate the length of the variable.

Thus, an aspect of one embodiment of system 100 entails giving each variable a global ID and associating with this ID one or more dynamic parameters that describe the variable type and length in the component 110, 120 to which it belongs. Moreover, the global IDs and descriptors in the NDSF data 115, 125 and the maps 150, 160 may be static once a load is created, or once a communication link between the components 110, 120 is established. Accordingly, the component 120 can employ the maps 150, 160 to understand how the component 110 encodes the NDSF data 115 and, consequently, translate the NDSF data 115 into NDSF data 125 for subsequent operations.

As described above, object-oriented programming may be employed to implement the system 100 and/or one or more of the components 110, 120. Since some embodiments described herein do not distinguish between class and structure, the construct concept is used from this point forward, and it is meant to indicate either a class or structure. In the following constructs:

struct myData
{
int w;
int x;
};
struct myRoot
{
int xx;
struct myData y;
} z;

the redundancy variable x belongs to myData, and myData is included in myRoot. Either may change in size, and the variable x may also change location within myData. The variable x may also change property or storage format (e.g., most-significant byte first or last, character or integer, signed or unsigned, etc.) while serving the same function within myData and myRoot. These changes may affect the storage location for the variable x value within the constructs. However, once the constructs are defined, the offset location may remain fixed in the construct in which the data originates. Objectives for a receiving component, such as the component 120 in FIG. 1, include: (1) correctly locating variable x; (2) obtaining the assigned value for variable x; and then (3) passing the value to a variable serving the same purpose in its own native structure. Locating the variable x may be handled by employing a global ID that ties the variable x in a sending component, such as component 110 in FIG. 1, to a variable serving the same purpose in the receiving component. Additional information can be attached to the global ID that specifies the encoding attribute of the variable (such as size, offset, repeatability, etc.) in the sending and receiving components. These additional attributes may allow a receiving component to locate the variable x in the message text, and to correctly transfer the information to an equivalent native variable.

In this manner, the variable ID, type, offset, length, and value from the encoding system (component 110 in this case) may be communicated to a receiving component. The global ID and the encoding attributes assigned to the variable may be arranged into a structure which may be known as a translation map element. The collection of the translation map elements may be referred to as a translation map, such as the maps 150, 160.

Moreover, because the type, offset, and length of each variable may remain constant within a component 110, 120, the variable definitions and/or other information contained in the maps 150, 160 may be exchanged only once at the start of a communication cycle. That is, the information exchanged in the maps 150, 160 may be saved internally by each component 110, 120 and consulted when new data is received.

The system 100 may also include tags to assist the component 120 with decoding the data received from the component 110, such as by pointing the component 120 to the definition of the variables 125a-e. In one embodiment, each tag is a combination of a global class number and a local class construct number. A class number may be a unique number given to a class when the class is added to a system, such as during coding time. The construct number is internal to the class and is assigned when new structures are added to the class (1, 2, 3, etc.).

Using the above tags in messages transmitted between the components 110, 120, the receiving component is able to locate the class and the construct descriptors specific to the messages in the descriptors provided in the maps 150, 160. When descriptors are found, the construct definitions for the corresponding variables (e.g., global IDs, types, offsets, and/or lengths) are used to parse the received message. The receiving component can then search the local descriptors for the same tag. If a local construct description is found, each variable's global ID can be matched to one of the received variable's global ID. If a match is found, the value of the received field can be copied into the local variables. All variables that did not have a match to any of the received variables may be processed afterwards, as this implies that they are newly defined or no longer supported. If these undefined variables did not specify default-initializers, they may be set to zero. Otherwise, the initializers may be called. This decoding operation can be highly recursive, because structures tend to include other structures. Once the conversion is complete, the newly formed message can be passed to a unique class registered function to process the contents.

Macros and/or other coding techniques, possibly including those supported by one or more C++ ANSI compilers, may be employed to define the description of each variable within each construct. For example, all global IDs may be assigned in a single file using one or more macros. Such macros may use the structure name as a parameter and concatenate additional characters to provide global references. The following macros may be employed in at least one embodiment within the scope of the present disclosure.

The macro:
#define ClassEnum(name) Class_##name
   returns a global redundancy class name that is used to assign a global ID to a root construct name. The reference to root implies that this Assigned ID is a part of all construct IDs defined for this class. The combined ID of this class and the ID of any local construct may be sent as a message or tag to the receiving component. All internal definitions may use Class_##name as an internal variable.

The macro:
#define ConstructEnum(y,x) y::LocalConstruct_##x
   returns an enumerated value that defines the local constructs (protected) ID within a root construct. Inherited classes may use this construct in their own constructs.

The macro:
#define offset(x,y) ((ushort) &((x *)0)−>y)
   returns the offset of variable y in construct x.

The macro:
#define rsize(x,y) sizeof(((x *)0)−>y)
   returns the size of variable y, in construct x, in bytes.

The macro:
#define RedEnum(variable) LVN_##variable
   defines a global redundancy name for “variable”.

The macro:
#define DefRedConstruct(version,name) StrctVer_##name=version, StrctNum_##name
   defines a global variable version and name for construct “name”.

The macro:
#define defconstruct(name) newConstruct(StrctNum_##name,StrctVer_##name)
   defines storage for construct “name”.

The macro:

```
#define element( name, variable, type, callback) \
      COMPONENT::describRedElement( \
        COMPONENT::RType_##type, \
        offset(name,variable), \
        name::LVN_##variable, \
        sizeof(RStorage_##type), \
        1,callback)
```

defines storage for “variable” of type “type” in construct “name” with convert function “callback”. Default conversion for these variables follows the standard conversion types (e.g., short to long or long to short).

The macro:

```
#define elementStruct( name, variable, callback) \
      COMPONENT::describRedElement( \
        COMPONENT::RedObject_sequenced, \
        offset(name,variable), \
        name::LVN_##variable, \
        rsize(name,variable), \
        1,callback)
```

defines storage for “variable” of type structure in construct “name” with convert function “callback”. This call is used to define elements that need to remain intact and to be treated as a sequence of memory locations. Default conversion for these variables include right-most truncation or padding with zeros.

The macro:

```
#define elementArray( name, variable, type, repeat, callback) \
      COMPONENT::describRedElement ( \
        COMPONENT::RType_##type, \
        offset(name,variable), \
        name::LVN_##variable, \
        sizeof(RStorage##type), \
        repeat,callback)
```

defines storage for “variable” of type array in construct “name” of type “type” with an array bound of “repeat” and default conversion “callback”. This macro is used to define an array element of standard type (char, short, long, uchar, ushort, etc.). Default conversion is applied to each element of the array, array size may be truncated, or larger arrays may be filled with zeros for the additional array elements.

```
#define elementStructArray( name, variable, repeat, callback) \
      COMPONENT::describRedConstruct ( \
        COMPONENT::RedObject_sequenced, \
        offset(name,variable), \
        name::LVN_##variable, \
        rsize(name,variable)/repeat, \
        repeat,callback)
```

The macro:

defines storage for “variable” as an array of structures in construct “name” with an array bound of “repeat” and default conversion “callback”. This macro is used to define an array element of non-standard type (memory area). Default conversion is applied to each element of the array (each element may be padded with zeros or truncated from the right), array size may be truncated, or larger arrays may be filled with zeros for the additional array elements.

The macro:

```
#define construct( owner, vclass, vstrct, variable) \
      COMPONENT::describRedConstruct( \
        ClassEnum(vclass), \
        vclass::StrctNum_##vstrct, \
        owner::LVN_##variable, \
        offset(owner,variable),1 )
```

defines storage for “variable” as defined in “owner by a previously defined construct with global ID of <vclass><vstruct>.

The macro:

```
#define constructArray( owner, vclass, vstruct, variable, repeat )\
      COMPONENT::describRedConstruct( \
        ClassEnum(vclass), \
        vclass::StrctNum_##vstruct, \
        owner::LVN_##variable, \
        offset(owner,variable), repeat )
```

defines storage for “variable” as an array of size “repeat” in “owner”. Each array element is defined by a previously defined construct with global ID<vclass><vstruct>.

The macro:

```
#define control( name, controler, controled, control_type )\
      COMPONENT::describRedControl ( \
        name::LVN_##controler, \
        name::LVN_##controled, \
        control_type )
```

defines a relation ship between two variables with in a construct “name”. The controller controls the “control_type” aspect of the “controlled” variable.

The macro:

```
#define redClass( rclass, callback ) \
      COMPONENT::defineRedClassDesc( \
        ClassEnum(rclass), callback )
```

defines a function to call when construct “rclass” message is received and converted.

Using the above macros, implementation may be split into imbedded code in each class that is employed in the system (“imbedded code”) and generic code. To demonstrate an embodiment of such implementation, consider two systems, System A and System B, in which System A is a newer system that has evolved and has redefined some of its variables to accommodate additional requirements. This evolution caused the structures in System A to change in size and element count. Consequently, after taking System A offline to accomplish this update, System A needs to be brought online with the data from system B, which is still operating online. System B has been online or in the field for some time, and includes the original structures requiring updating. System B may also be considered a legacy component, such that System A may comprise an upgrade to the legacy component. In one embodiment, Systems A and B may be analogous to components 110 and 120, respectively, in the system 100 of FIG. 1.

The following structures may be defined in System A:

| struct newStuff | |
|---|---|
| { | |
| int x; | |
| int y; | |
| }; | |
| struct enhancedOldStuf | |
| { | |
| int x; | |
| int y[10]; | |
| } | |
| struct syncThis | |
| { | |
| int z; | |
| int w; | |
| struct enhancedOldStuf old; | |
| struct newStuff | new; |
| struct other_stuff | stuff; |
| }; | |

The following structures may be defined in System B:

struct oldStuf
{
int x;
int y[5];
}
struct syncThis
{
int z;
struct oldStuf old;
int w;
struct other_stuff stuff;
};

Notice that the upgrades to System A, via one or more revisions, has changed the syncThis construct drastically. The above example is referenced in the following discussions. However, those skilled in the art will appreciate that this example is presented merely to demonstrate aspects of system 100, and is not scope-limiting in nature. That is, there are myriad ways to accomplish the data translation via map exchange according to aspects of the present disclosure other than the specific code provided herein. Thus, any absolutes employed to describe the code particular to the present example in no way limit the scope of applicability and/or adaptability of system 100 to other scenarios.

Each class that belongs to Systems A or B has a class number that is globally defined. This class number may not be reused by other classes or changed by this class. The class defines an initializing method that may be called to get the constructs the class wishes to use.

The following definitions may be found in System B, including the global class syncThis, which may be maintained across several systems, including Systems A and B.

Enum // class global IDs
{
// other classes..
ClassEnum(syncThis) = 23, // define syncThis globally as 23
// more classes..
};

In the implementation of the syncThis class, the class definition may include:

```
Class syncThis // system B definition of class syncThis
{
  // Redundancy descriptors.... structures that are
  // passed between the standby and the active systems
  // can have a definition here...
  //---------------------------------------------------
  struct RedOldStuf
  {
  enum RedOldStuff_Objects
  {
  RedEnum(x)  = 1,
  RedEnum(y)  = 2,
  EndofRedOldStuff_Objects
  };
  int x;
  int y[5];
};
Struct RedSyncThis // message sent to other COMPONENT that has
syncThis Class
{
  enum RedSyncThis_Objects
  {
```

| | |
|---|---|
| RedEnum(z) | = 1, |
| RedEnum(old) | = 2, |
| RedEnum(w) | = 3, |
| RedEnum(stuff) | = 4, |

```
    EndofRedSyncThis_Objects
  };
  int  z;
```

| | |
|---|---|
| RedOldStuff | old; |

int w;

| | |
|---|---|
| struct other_stuff | stuff; |
| }; | |

```
// construct number control
enum LocalRedConstructs
{
  DefRedConstruct(0, RedSyncThis) = 1,
  DefRedConstruct(0, RedOldStuff) = 2,
  EndofLocalRedConstructs
  };
public:
  static PASSFAIL describeRedConstructs( ); // called by COMPONENT
  only
private:
  // COMPONENT call back...
  static PASSFAIL processMsgFromActiveCpu(ushort pDataConstNum,
  void
*pMsgData);
  // other stuff for this class..
};
```

An implementation method that describes the construct for the class syncThis is provided below. As described above, this method may only be called once, such as at initialization. An internal structure may then be built and exchanged with another system, which may use this description to parse an incoming RedSyncThis message from System B.

```
//static
PASSFAIL syncThis::describeRedConstructs( )
{
  PASSFAIL rc = FAIL;
  RedTypeDefs::RedClassDesc *classptr;
  classptr = redClass(syncThis,processMsgFromActiveCpu);
  if ( classptr )
  {
```

```
do
{
  // now define the redundancy constructs
  RedTypeDefs::RedConstructDesc *consptr;
  consptr = classptr->defConstruct(RedSyncThis);
  if ( consptr )
  {
```

// define the construct
consptr->element(RedSyncThis,z,int,0);
consptr->construct(RedSyncThis,syncThis,RedOldStuff,old);
consptr->element(RedSyncThis,w,int,0);
consptr->elementStruct(RedSyncThis,stuff,0);

```
  }
  else
```

break;

```
  consptr = classptr->defConstruct(RedOldStuff);
  if ( consptr )
  {
```

// define the construct
consptr->element(RedOldStuff,x,int,0);
consptr->elementArray(RedOldStuff,y,int,5,0);

```
  }
  else
```

break;

rc = PASS;
}while(0);

}
return rc;

};

Note that, from the description, all the described variables may rely on a default conversion function of a system to handle missing variables or variables of different type and size. Also note that this class registers its callback function (processMsgFromActiveCpu( )) used to process any message that is marked with this class tag.

The next method that each class may have is a function that processes the construct received on its behalf. This function may be registered when the class descriptor is instantiated. The data received by this function should have been already in the correct position according to the defined local constructs.

PASSFAIL syncThis::processMsgFromActiveCpu (

ushort pDataConstNum,
void *pMsgData )

```
{
  PASSFAIL rc = pass;
  switch(pDataConstNum)
  {
  case RedTypeId(RedSyncTis):
```

// process the received data
break;

default:

error (“syncThis: Invalid Construct Id(%d) received”,

pDataConstNum );

rc = fail;
break;

```
  }
  return rc;
}
```

Now examine the definition used by system A. Since system A is a modification of the old system, some of the data has the same meaning but has additional storage to handle new requirements. The following is the class syncThis definition in system A:

```
Class syncThis // system A definition of class syncThis
{
// redundancy descriptors....All structures that are
// passed between the standby and the active systems
// must have a definition here...
//---------------------------------------------------
struct RedEnhansedOldStuff // renamed
{
  enum RedEnhansedOldStuff_Objects
  {
```

| | |
|---|---|
| RedEnum(x) = | 1, |
| RedEnum(y) = | 2, |

```
  Endof RedEnhansedOldStuff_Objects
  };
  int x;
  int y[10]; // changed the size...
};
struct RedNewStuff // new data
{
  enum RedNewStuff_Objects
  {
```

| | |
|---|---|
| RedEnum(x) | = 1, |
| RedEnum(y) | = 2, |

```
  EndofNewOldStuff_Objects
  };
  int x;
  int y[5];
};
Struct RedSyncThis // message sent to other COMPONENT that has
syncThis Class
{
  enum RedSyncThis_Objects
  {
```

| | |
|---|---|
| RedEnum(z) | = 1, |
| RedEnum(old) | = 2, |
| RedEnum(w) | = 3, |
| RedEnum(stuff) | = 4, |
| RedEnum(new) | = 5, |

```
  EndofRedSyncThis_Objects
  };
  int  z;
  int  w; // location moved to save storage
  RedEnhansedOldStuff old;
  RedNewStuff  new;
  struct other_stuff stuff;
};
// construct number control
enum LocalRedConstructs
{
```

DefRedConstruct(1, RedSyncThis) = 1, // version 0 07/01/02

// version 1 11/01/02

DefRedConstruct(1, RedEnhansedOldStuff) = 2, // version 0 07/01/02

// version 1 12/08/02

DefRedConstruct(0, RedNewStuf) = 3, // version 0 08/08/03
EndofLocalRedConstructs
};
static PASSFAIL describeRedConstructs( );
static PASSFAIL processMsgFromActiveCpu(ushort
pDataConstNum,void

*pMsgData);
// other stuff for this class..
};

Note that, from the above definition, the RedOldStuff has been renamed but its ID remains the same (2). Also, the variable “w” has changed its place relative to the old definition but its ID remains the same (3). The new structure “NewStuff” has been added and is assigned a new ID (5) not present in system B. The remaining task is to code in the description of the variables. The following is the implementation of construct descriptions in system A.

```
//static
PASSFAIL syncThis::describeRedConstructs( )
{
  PASSFAIL rc = FAIL;
  RedTypeDefs::RedClassDesc *classptr;
  classptr = redClass(syncThis,processMsgFromActiveCpu);
  if ( classptr )
  {
  do
  {
    // now define the redundancy consructs
    RedTypeDefs::RedConstructDesc *consptr;
    consptr = classptr->defConstruct(RedSyncThis);
    if ( consptr )
    {
```

// define the construct
consptr->element(RedSyncThis,z,int,0);
consptr->element(RedSyncThis,w,int,0);
consptr->construct(RedSyncThis,syncThis,RedEnhansedOldStuff,
old);
consptr->construct(RedSyncThis,syncThis,RedNewStuff,new);
consptr->elementStruct(RedSyncThis,stuff,0);

```
    }
    else
```

break;

```
    consptr = classptr->defConstruct(RedEnhancedOldStuf);
    if ( consptr )
    {
```

// define the construct
consptr->element(RedEnhancedOldStuf,x,int,0);
consptr->elementArray(RedEnhancedOldStuf,y,int,10,0);

```
    }
    else
```

break;

```
    consptr = classptr->defConstruct(RedNewStuf);
    if ( consptr )
  {
```

// define the construct
consptr->element(RedNewStuf,x,int,0);
consptr->element(RedNewStuf,y,int, initialize_y);

```
    }
    else
```

break;

```
    rc = PASS;
    }while(0);
  }
  return rc;
  };
```

Note that the new “<RedNewStuf><y>” element specifies an initializer that may be called when a message is received from a remote system that does not have a definition for this variable.

Note also that classes specify how data is saved into an outgoing message by the order of the variables described. Thus, in encoding the “RedSyncThis” for a system B message, the value of variable “z” is placed first in the message, followed by the value of construct “old,” and so on. Similarly, in System A, the message is filled first with the value of variable “z,” followed by the value of variable “w,” and so on. This implies that, for any variables that have a controlled/controlling relationship, the “controlling” variables should be described before any of “controlled” variables. Thus, when parsing a message, a system will obtain the value of the “controlling” variable before the “controlled” variable is encountered, thus providing a correct parsing algorithm.

A “controlling” variable is a variable that controls some aspect of other “controlled” variables. For example, the controlling variable may specify the number of elements in an array that are passed in a message. Consequently, a construct may be defined with the maximum number of allowed records but may only populate one or more. Thus, the Systems A and B need to know this information to encode outgoing messages and, for incoming messages, to locate the control field and extract its value before encountering the controlled variable.

The generic code can be categorized into three sections: translation map database, initialization, and operation. The initialization section is involved at the start-up of a system and when a communication link is established with another system. The translation map database refers to the data that has to be saved by a system to allow a system to translate between local and remote message structures. The operation section is involved in encoding and decoding messages traveling between the application and communication layers of a system.

The translation map database consists of translation map elements that are linked together to form one or more tables or arrays. The tables/arrays may be indexed by the global ID of the elements. For example, in each system, a local table containing local or native descriptors may be created, as well as one or more remote tables containing remote descriptors native to other system(s). There are three types of descriptors which may populate the local and/or remote tables/arrays: class descriptors, construct descriptors, and variable descriptors. All the descriptors share a common header that defines their type, version, and length, etc. The descriptor header may be:

| typedef struct | |
|---|---|
| { // total 4 bytes header... | |
| ulong mDescVer:4, | // descriptor version.. 0-15 |

| | |
|---|---|
| mDescLength:4, | // size in words... |

| | |
|---|---|
| mDescRefType:4, | // enum RedDescRefType |

| | |
|---|---|
| mDescRefVersion:4, | // Ref version.. |
| mDescRefNum:16; | // Ref number |

} RedDescHdr;

The size of the descriptor header may be kept at thirty-two bits to minimize memory usage. The descriptor Version is used to specify the version of the descriptor. As stated before, these descriptors should rarely change, such that a range of 0-15 may be sufficient, but not mandatory. The descriptor length specifies the descriptor size in words. The descriptor type specifies the type of the descriptor as either a class, a construct or a variable. The version states the version of element using this descriptor. Each class and each construct may set the version value independently. Variables may not have a version. The reference number is the global ID assigned to variable using this descriptor.

The class descriptor may be:

| typedef struct | |
|---|---|
| { | |
| RedDescHdr mHdr; | |
| ulong mConstCount; | // total number of constructs assigned |
| | // by this class.. |

// private Additional data for house keeping
} RedClassElm;

This descriptor is defined once per class, and contains the total number of internal/local constructs defined by this class. In a house keeping section which may be private to each system, a link to each construct is saved. Since all constructs may be defined at initialization, the constructs can be allocated sequentially. In one embodiment, a single reference may be kept for each construct, the cumulative references thereafter accessible as elements in an array. Other variables are saved in the private data that are used for optimization, statistics, and other functions.

The construct descriptor may be:

typedef struct
{
RedDescHdr mHdr;
ulong mVarCount; // total number of Variables assigned

// by this construct..

// Additional data for house keeping
} RedConstElm;

This descriptor may be defined once per class construct, and may contain the total number of variables defined by the construct. A link to each variable descriptor may be saved in the housekeeping section. Since all variables in a construct may be defined sequentially at initialization, the variable descriptors may be allocated sequentially. In one embodiment, a single reference may be kept for each variable, the cumulative references thereafter accessible as elements in an array. Other variables may be saved in the private data that are used for optimization, statistics and other functions.

The variable descriptors may be:

typedef struct
{
RedDescHdr mHdr;

| | | |
|---|---|---|
| ulong | mObjectType:4, | // signed/unsigned struct ..etc |
| | mControlType:4, | // control type (on-off, arry index, .. |
| | mSpare:8, | // not used.. |
| | mControlRef:16; | // controled by Variable #mControlRef |
| ulong | mArrayCount:16, | // array max index value.. |
| | mLength:16; | |
| ulong | mVarData1:16, | |
| | mVarData2:16; | |

// Additional data for house keeping
} RedVarElm;

This descriptor may be defined once per variable in a construct, and may contain description of the variable as defined by the owning system. The object type refers to the type of variable this descriptor is trying to describe. Valid types include signed, unsigned, sequenced, or RedConstruct. Signed and unsigned have the normal standard meaning (truncation and padding is done on the left, and the sign bit must remain intact). Sequenced variables may be considered raw memory, and may be truncated from the right or padded on the right with zeros. No meaning may be attached to sequenced variables. RedConstruct variables refer to a predefined construct, and a system should search the table for their definition. Control reference may be set to zero unless this variable is controlled by another variable in the same construct, in which case the control reference may refer to the variable reference number. The array count is set to how many times this variable repeats, such as being set to one. Two 16-bit data values may also be saved with this descriptor to be used depending on the descriptor type.

In the house keeping section, additional storage may be used to keep track of variable correlation between the local system descriptors and the remote system descriptors. The storage may be used for optimization.

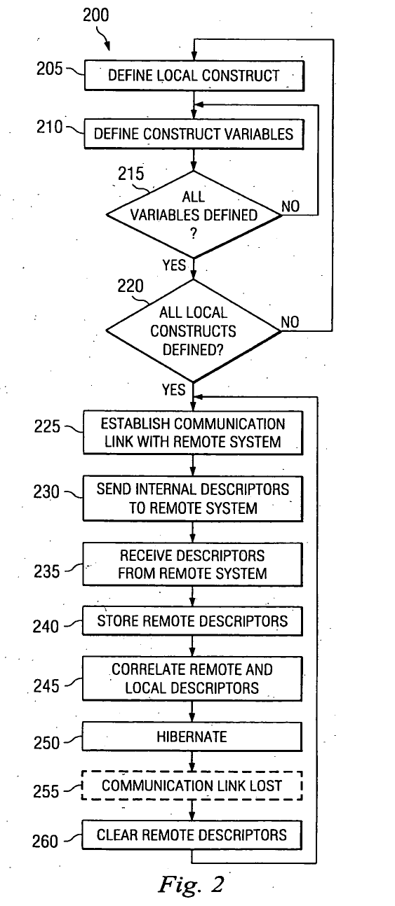

Referring to FIG. 2, illustrated is a flow-chart representing one embodiment of an initialization method 200 according to aspects of the present disclosure. At an initial step 205, the local system may initialize an internal local system table that holds the description of all pertinent variables, as well as a remote system table. However, a remote system table within the local system may remain empty as long as a communication link with a remote system is down. The descriptions of the variables may be obtained by calling all classes' describeRedConstructs( ) method. This method makes repeated calls to define the local constructs and the variables within these constructs, such as with the function implementation above. For example, the method may include a step 210 in which construct variables are individually defined until each variable within the construct is defined, as determined by a decisional step 215. This process may be repeated for each individual local construct until each construct is defined, as determined by a decisional step 220. Each call may thus add an element to the local system table. Once all the classes have been called, which indicates that all descriptions are now available, a step 225 is performed to establish a communication link with a remote system.

When the communication link is established with the remote system, the local system sends its internal descriptors to the remote system in a step 230. The local system may also expect the remote system to send its own definitions in a step 235. For example, when a message from the remote system containing the descriptors arrives, the message is parsed according to the system internal structure and the definitions are saved into the remote system link list and/or inserted into the remote system table in a step 240. The definitions may be sent such that each message contains an integral number of class-constructs. That is, in one embodiment, no partial constructs may be sent in any message. Once the remote descriptors are received, verification of the contents of each descriptor is attempted and a correlation is created between the remote and local classes, constructs, and variables in a step 245.

The initialization method may then hibernate in a step 250. However, the initialization stage may be reactivated if the communication link between the two systems is lost, which is depicted as a step 255 in the method 200, although this is more of an occurrence than a process step to be executed by the method. In such case, the remote system table may be cleared in a step 260, and the process of establishing the communication link and exchanging descriptors may be repeated.

Messages received before substantially completed reception of the remote system descriptors may be ignored. Moreover, messages may not be allowed to leave a system before a communication link is established between the local system and one or all remote systems with which the local system may potentially communicate.

To speed up parsing described above, the remote system descriptors may be correlated to the local system descriptors, such that the local system can determine if a received variable has a corresponding local definition. If the remote descriptor has no correlating local variable descriptor, it is marked as such. If the remote construct descriptor is found to be identical to the local construct descriptor, the construct is marked identical, and when such construct is received it is passed as-is to the application.

Moreover, in some embodiments the method 200 may not include each step illustrated in FIG. 2, may include steps in addition to those illustrated, and may perform the illustrated and other steps in sequences other than described above. For example, descriptors may not be transmitted in both directions. That is, one of the systems may generate only the local descriptor table and not generate the remote descriptor table. Messages sent to such a system may require translation prior to transmission.

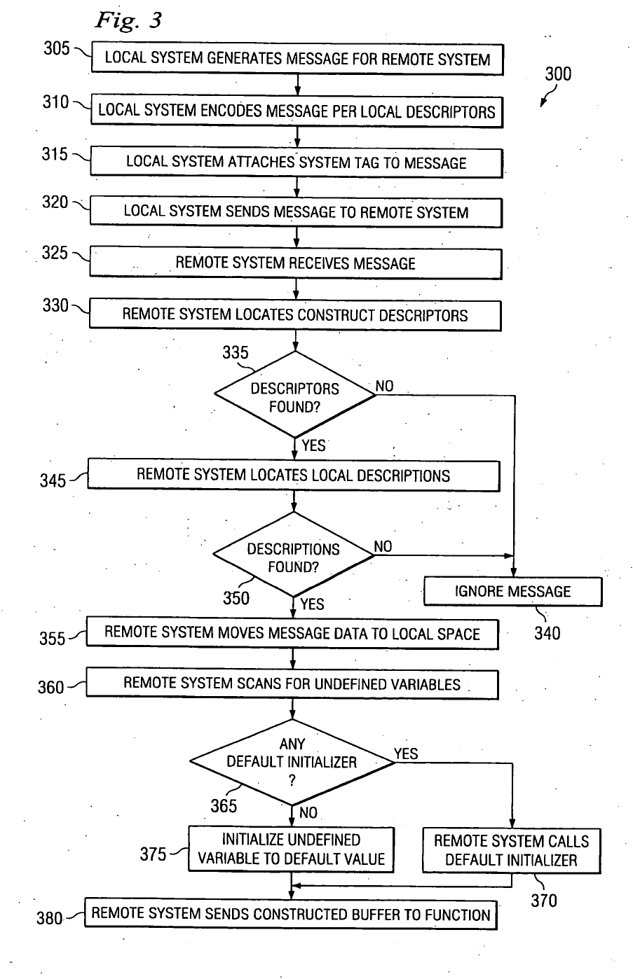

Referring to FIG. 3, illustrated is a flow-chart representing one embodiment of a method 300 for encoding and decoding messages according to aspects of the present disclosure. The operation stage deals with the interface between the application and the system communication link, including message encoding and decoding. When the application has changed a structure and the change must be sent to the remote system, the application fills in the structure with the required data and calls system operation methods to send the data, as depicted in a step 305 of the method 300. The operation section receives the data from the application and encodes the data according to the local system descriptors one variable at a time in a step 310. Once encoding is complete, system attaches a system tag to the message in a step 315, and the message is sent to the remote system in a step 320.

The system tag allows the remote system to decode the message correctly. An exemplary structure for the system tag is:

```
typedef struct
{
  ushort mClassRef;
  ushort mConstRef;
} RedDataSyncHdr;
```

The class reference is the globally assigned class reference number (in the present example it is 23) and the construct reference number is the reference number of the construct within that class (in the present example it is 1). This information is sufficient to allow the remote system to locate the relevant description.

The remote system receives the message in a step 325 and, using the system tag, locates the construct descriptor in the remote system table in a step 330. If the construct descriptor cannot be located, as determined in a decisional step 335, the message is ignored (step 340). With the construct descriptor in hand, the remote system attempts to locate the local description from the local system table in a step 345. If a local descriptor is not found, as determined in a decisional step 350, the message is ignored (step 340).

Using the local construct descriptor, the remote construct descriptor, and the message data section, the remote system moves the data from the message space into the local space one variable at a time in a step 355. At this time, conversion, truncation, and padding of the variable value may take place. Once all incoming variables are moved into the local buffer, the local construct descriptor is scanned in a step 360 for any variable that has not been defined by the message source system. If an un-initialized variable is found, the variable descriptor is consulted for a default initializer. If an initializer is found, as determined in a decisional step 365, the initializer function is called in a step 370. Otherwise, the variable is initialized to zero or some other default value in a step 375. After the construct descriptor has been decoded, the constructed buffer is sent to a processing function, such as the class registered processing function (processMsgFromActiveCpu( )), for content manipulation in a step 380. In some embodiments, the method 300 may not include each step illustrated in FIG. 3, may include steps in addition to those illustrated, and may perform the illustrated and other steps in sequences other than described above.

In one embodiment, such as that in which a system or network has N:M redundancy, a system can be configured to keep data from several remote systems. However, in such an embodiment, all transmitted data may be relative to its own system definitions, such that the burden of conversion lies with the receiving system.

Looking back at the example above, note that the order of the variables is handled by matching the remote system variable to a variable in the local system. Thus, the value of the variable “w” (with ID of 23.1.3) may be set correctly from the received “w” (also with an ID of 23.1.3). Similarly, the name change from “RedOldStuff” to “REDEnhancedOldStuf” may be correctly handled by the global ID (23.2), since both constructs have the same ID and the name is, therefore, irrelevant.

For the variables “y[5]” and “y[10],” if the data is moving from System B to System A, then the remaining elements (y[5]-y[9]) are set to zero. However, if the data is moving from System A to System B, then the extra elements may be truncated. The new construct “newStuf” is not defined in System B and, therefore, has no description in the remote system table in System A. After the remote COMPONENT construct variables in System A have been processed, the “newStuf” storage space is initialized. To initialize this space, the system initializes each variable within the construct such that, in this case, variable x is set to zero while y is set by calling initialize_y( ) defined by the variable descriptor. The resulting buffer is then passed to the class registered processing function (processMsgFromActiveCpu( )).

Some embodiments of the present disclosure may be useful in removing the burden of keeping track of individual variables and structures, as well as assisting in the definition of standardized processes, methods, and systems for achieving less complicated addition and/or removal of variables between systems having different native data structure formats or that are otherwise incompatible. Some aspects of the present disclosure may also provide users the flexibility to include predefined structures within messages and the ability to change imbedded structures as such a need arises. Aspects of the present disclosure may also provide the ability to automatically reformat remote variables to match the format of local variables, such as between big Endian and little Endian formats, or among character, short, long, etc. Moreover, in some embodiments, automatic conversion routines may be provided internal to one or more components in a system or systems, which can enhance transparency and relieve users from such conversion tasks.

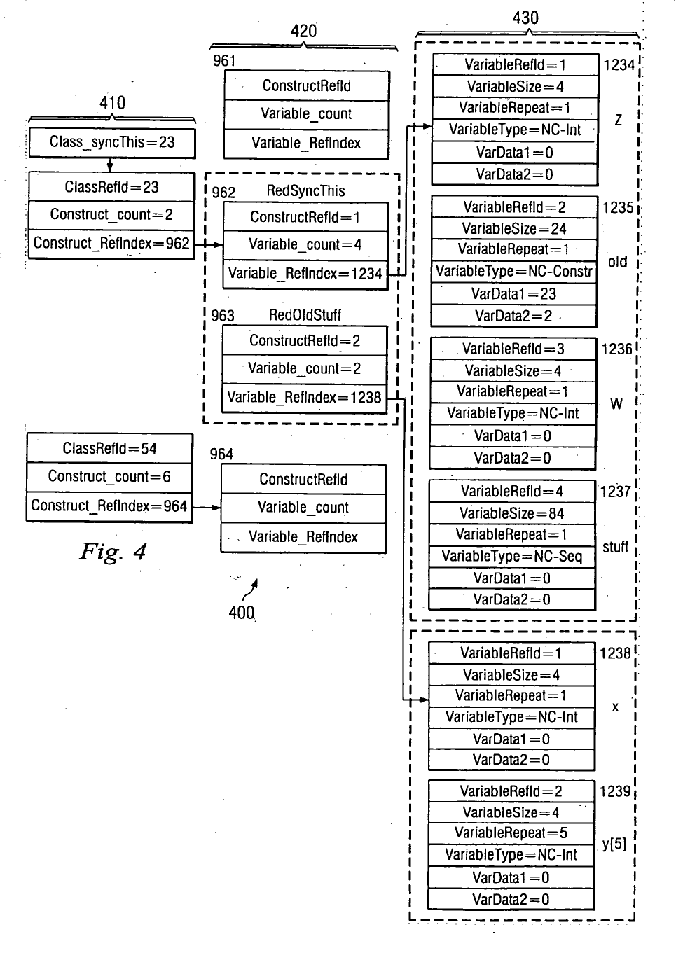

Referring to FIG. 4, continuing with the example above, illustrated is a block diagram of a portion of one embodiment of a database 400 for System B. As discussed above, System B is one that has been online or in the field for some time, and includes original structures requiring updating in response to the upgrade of System A. The database 400 includes a class definition array 410, a construct definition array 420, and a variable definition array 430.

For example, the class definition array 410 includes an entry “ClassRefId” for the class_syncThis and having the value “23,” an associated “Construct_count” having the value “2,” and an associated “Construct_Refindex” having the value “962.” The “ClassRefId” is unique to the class. The “Construct_count” indicates the number of construct definitions in an instance of “ClassRefId.” For example, in the illustrated embodiment, the class_syncThis includes the constructs RedSyncThis and RedOldStuff. The “Construct_Refindex” indicates the location of the first construct definition in the construct definition array 420.

Continuing with this example, the construct RedSyncThis is element 962 in the construct definition array 420, has an ID “ConstructRefId” of “1,” and includes four variables per the “Variable_count,” wherein the first variable is element 1234 in the variable definition array 430, per the “Variable_Refindex.” The 4 variables in the RedSyncThis construct are “z,” “old,” “w,” and “stuff,” which agrees with the code described above. As shown in the variable definition array 430, each of these variables may include or have associated therewith a “VariableRefId” indicating the variable's position within the construct, a “VariableSize” indicating the length of the variable, a “VariableRepeat” indicating the number of times the variable is to be repeated within the construct, and a “VariableType” indicating the type of the variable. Each variable definition may also include one or more pointers to locations in which other data is stored, as indicated by the “VarData1” and “VarData2” also illustrated in FIG. 4.

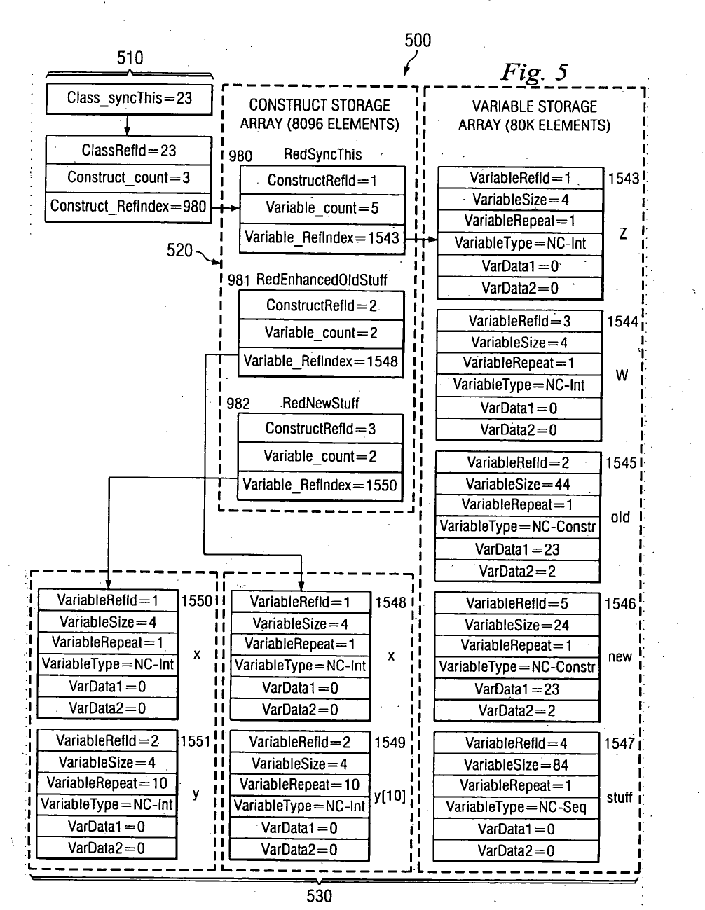

Referring to FIG. 5, illustrated is a block diagram of a portion of one embodiment of a database 500 for System A, continuing with the above example. As described above, System A is a newer system that has evolved and has redefined some of its variables to accommodate additional requirements. The database 500 includes a class definition array 510, a construct definition array 520, and a variable definition array 530.

For example, the class definition array 510 includes an entry “ClassRefId” for the class_syncThis and having the value “23,” an associated “Construct_count” having the value “3,” and an associated “Construct_Refindex” having the value “980.” In the illustrated embodiment, the class_syncThis includes the constructs RedSyncThis, RedEnhancedOldStuff (partially corresponding to the construct RedOldStuff in System B), and RedNewStuff.

The construct RedSyncThis is element 980 in the construct definition array 520, has an ID “ConstructRefId” of “1,” and includes five variables per the “Variable_count,” wherein the first variable is element 1543 in the variable definition array 530, per the “Variable_Refindex.” The five variables in the RedSyncThis construct are “z,” “w,” “old,” “new,” and “stuff,” which also agrees with the code described above. As shown in the variable definition array 530, each of these variables may have definitions similar to those in the variable definition array 430, although they may not be in the same sequence. For example, the order of the variables “w” and “old” are different in the variable definition arrays 430, 530. However, the “VariableReFId” of these variables remains constant in the variable definition arrays 430, 530, and the additional variable “new” introduced by the upgraded System A has been assigned the next available “VariableRefId” (5).

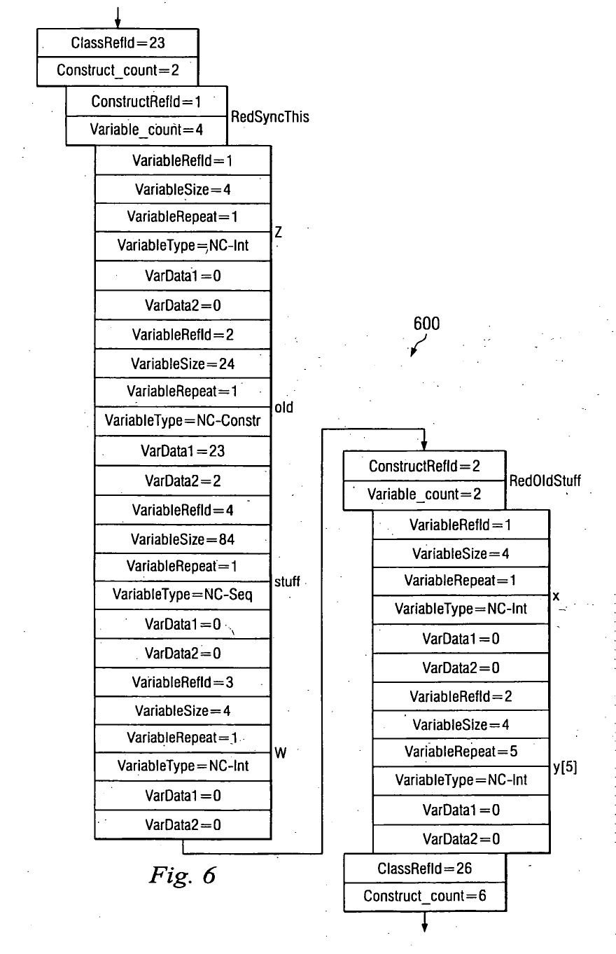

Referring to FIG. 6, illustrated is a block diagram of a portion of one embodiment of a descriptor message or map 600 that older System B may send to newer System A to assist System A with translation of messages received from System B. Although the map 600 may include descriptors for multiple classes, only the descriptors for the class syncThis are shown in FIG. 6.

The map 600 includes a “ClassRefId” of 23 indicating that the immediately following information pertains to the class “syncThis.” The map 600 also includes a “Construct_count” of 2, indicating that “syncThis” includes two constructs. The first construct “RedSyncThis” has a “ConstructRefId” of 1, and includes four variables, per the “Variable_count”. The map 600 then lists the definitions for each of the variables “z,” “old,” “stuff,” and “w” included in the construct “RedSyncThis.”

The second construct “RedOldStuff” has a “ConstructRefId” of 2, and includes two variables, per the “Variable_count.” The two variables in the construct “RedOldStuff” include “x” and “y[5],” which is an array of five elements. The map 600 then lists the definitions for “x” and “y[5],” and continues to the next class (having a “ClassRefId” of 26).

Thus, System A may consult the map 600 to gather information pertaining to the format/structure of the class “syncThis,” the constructs “RedSyncThis” and “RedOldStuff,” and the variables “z,” “old,” “stuff,” “w,” “x,” and “y[5]” to process messages and/or data received from System B. Moreover, System B may continue to send such information in its native format, regardless of the format System A uses for native operations.

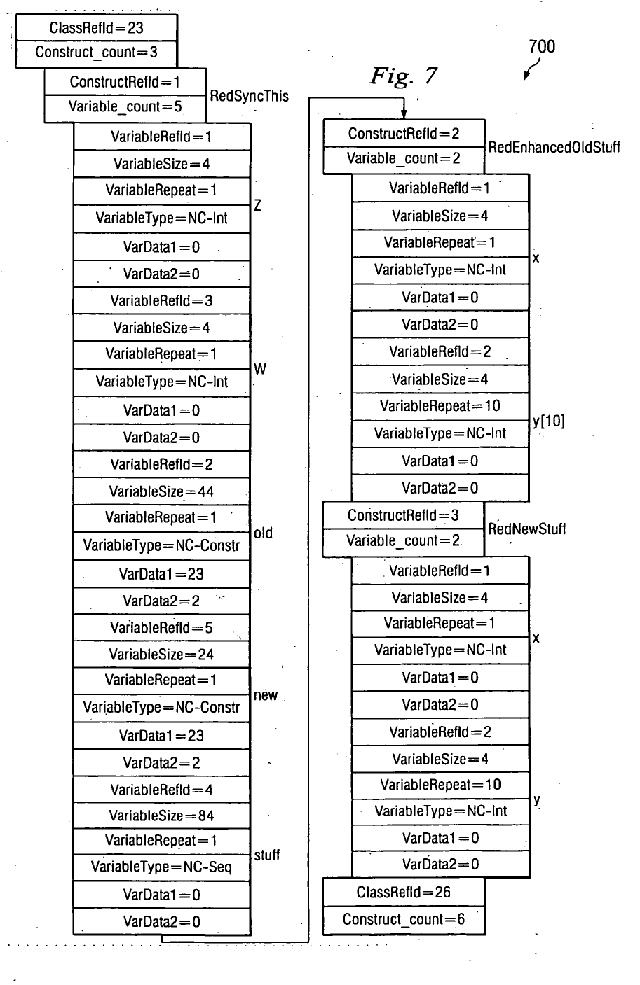

Referring to FIG. 7, illustrated is a block diagram of a portion of one embodiment of a descriptor message or map 700 that System A may send to System B to assist System B with translation of messages received from System A. Although the map 700 may include descriptors for multiple classes, only the descriptors for the class syncThis are shown in FIG. 7.

The map 700 includes a “ClassRefId” of 23 indicating that the immediately following information pertains to the class “syncThis.” The map 700 also includes a “Construct_count” of 3, indicating that “syncThis” includes three constructs. The first construct “RedSyncThis” has a “ConstructRefId” of 1, and includes five variables, per the “Variable_count”. The map 700 then lists the definitions for each of the variables “z,” “w,” “old,” “new,” and “stuff” included in the construct “RedSyncThis.”

The second construct “RedEnhancedOldStuff” has a “ConstructRefId” of 2, and includes two variables, per the “Variable_count.” The two variables in the construct “RedEnhancedOldStuff” include “x” and “y[10],” which is an array often elements. The map 700 then lists the definitions for “x” and “y[10].”

The third construct “RedNewStuff” has a “ConstructRefId” of 3, and includes two variables, per the “Variable_count.” The two variables in the construct “RedNewStuff” include “x” and “y.” The map 700 then lists the definitions for “x” and “y,” and continues to the next class (having a “ClassRefId” of 26). Note that the variables “x” and “x” are similarly named. However, by using global IDs, such as those based on the class number, the construct number within the class, and the variable number within the construct, the similar names may not be problematic. For example, the global ID for the variable “x” in the construct “RedEnhanced OldStuff” may be 23.2.1, whereas the global ID for the variable “x” in the construct “RedNewStuff” may be 23.3.1.

Thus, System B may consult the map 700 to gather information pertaining to the format/structure of the class “syncThis,” the constructs “RedSyncThis,” “redEnhancedOldStuff,” and “RedNewStuff,” and their variables to process messages and/or data received from System A. Moreover, System A may send such information in its native format, regardless of the format System B uses for native operations.

The present disclosure introduces a method of exchanging data between first and second components having first and second native data structure formats, respectively. In one embodiment, the method includes exchanging native data structure format information between the first and second components, generating data in the first native data structure format, and transmitting the generated data between the first and second components. The generated data is translated into the second native data structure format based on the exchanged native data structure format information.

A processing system for exchanging messages between first and second components having first and second native message formats, respectively, is also introduced in the present disclosure. In one embodiment, the processing system includes means for exchanging native data structure format information between the first and second components, means for generating data in the first native data structure format, and means for transmitting the generated data between the first and second components. Such an embodiment also includes means for translating the generated data into the second native data structure format based on the exchanged native data structure format information. The exchanging means, generating means, transmitting means, and translating means may be included in one or more processors or other components of a computer or network, such as the components 110, 120 shown in FIG. 1.

The method of exchanging messages between first and second components having first and second native message formats, respectively, may also be implemented or embodied in a program product according to aspects of the present disclosure. In at least one embodiment, such a program product may include means recorded on a computer-readable storage medium for exchanging native data structure format information between first and second components having first and second native message formats, respectively. The program product also includes means recorded on the medium for generating data in the first native data structure format, and means recorded on the medium for transmitting the generated data between the first and second components. Means also recorded on the medium are configured to translate the generated data into the second native data structure format based on the exchanged native data structure format information. The storage medium may be or comprise a magnetic recording medium, an optical recording medium, or a network distribution recording medium, such as may be employed to distribute the program product over (or “post”) a LAN, a WAN, the Internet, and/or other networks.

The foregoing has outlined features of several embodiments according to aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

1. A method of exchanging data between first and second components having first and second native data structure formats, respectively, comprising:
exchanging native data structure format information between the first and second components;
generating data in the first native data structure format;
transmitting the generated data between the first and second components;
translating the generated data into the second native data structure format based on the exchanged native data structure format information.

2. The method of claim 1 wherein the exchanged data structure format information includes first data structure format information corresponding to the first native structure format and second data structure format information corresponding to the second native structure format.

3. The method of claim 2 wherein exchanging includes the sending the first data structure format information from the first component to the second component and sending the second data structure information from the second component to the first component.

4. The method of claim 3 wherein the exchanging occurs before the generating.

5. The method of claim 3 further comprising establishing a communication link between the first and second components, wherein the exchanging of native data structure format information occurs substantially immediately after the communication link is established.

6. The method of claim 1 wherein the exchanged data structure format information includes a global ID for each of a plurality of variables included in the generated data.

7. The method of claim 6 wherein each global ID is based on a class and a construct by which the corresponding variable is defined.

8. The method of claim 6 wherein each global ID is based on a class, a construct, and a variable number by which the corresponding variable is defined.

9. The method of claim 6 wherein each global ID is based on a location of the corresponding variable within a construct.

10. The method of claim 6 wherein each global ID is based on a location of the corresponding variable within a class.

11. The method of claim 1 wherein the exchanging, generating, transmitting, and translating are implemented via object-oriented programming.

12. The method of claim 1 wherein the exchanging occurs before the transmitting.

13. The method of claim 1 wherein the exchanging occurs after the transmitting.

14. The method of claim 1 wherein the exchanging and the transmitting occur substantially simultaneously.

15. The method of claim 1 wherein the translating occurs after the transmitting.

16. The method of claim 1 wherein the translating occurs before the transmitting.

17. The method of claim 1 wherein the first and second components are within a single computer.

18. The method of claim 1 wherein the first and second components are within a single switch.

19. The method of claim 1 wherein the first and second components are within a single server.

20. The method of claim 1 wherein the first and second components comprise a legacy component and an upgraded version of the legacy component.

21. The method of claim 1 wherein the translating includes converting received generated data between first and second data types.

22. The method of claim 21 wherein the first and second data types are each one of big Indian and little Indian.

23. The method of claim 1 wherein:
exchanging native data structure formation information includes transmitting first native data structure format information generated by the first component from the first component to the second component; and
translating the generated data into the second native data structure format includes correlating IDs in the first native data structure format information with associated IDs in second native data structure format information generated by the second component.

24. The method of claim 1 wherein the translating includes truncating variable values based on the exchanged native data structure format information.

25. The method of claim 1 further comprising initializing variables not found in the generated data.

26. The method of claim 25 wherein the initializing includes storing default values for the variables not found in the generated data.

27. The method of claim 25 wherein the initializing includes storing user-input values for the variables not found in the generated data.

28. The method of claim 25 wherein the initializing includes storing values for the variables not found in the generated data based on user-specified conditions.

29. A processing system for exchanging messages between first and second components having first and second native message formats, respectively, comprising:
means for exchanging native data structure format information between the first and second components;
means for generating data in the first native data structure format;
means for transmitting the generated data between the first and second components; and
means for translating the generated data into the second native data structure format based on the exchanged native data structure format information.

30. The processing system of claim 29 wherein the exchanging means includes means for sending first data structure format information from the first component to the second component and means for sending second data structure information from the second component to the first component.

31. The processing system of claim 29 further comprising means for establishing a communication link between the first and second components, wherein the means for exchanging native data structure format information is responsive to the establishment of the communication link.

32. The processing system of claim 29 further comprising means for generating a global ID for each of a plurality of variables included in the generated data.

33. The processing system of claim 29 wherein the exchanging means, generating means, transmitting means, and translating means comprise object-oriented programming means.

34. The processing system of claim 29 wherein the first and second components are within a single computer.

35. The processing system of claim 29 wherein the first and second components are within a single switch.

36. The processing system of claim 29 wherein the first and second components are within a single server.

37. The processing system of claim 29 wherein the first and second components comprise a legacy component and an upgraded version of the legacy component.

38. A program product, comprising:
a computer-readable storage medium having a method encoded thereon, the method comprising;
exchanging native data structure format information between first and second components having first and second native message formats, respectively;
generating data in the first native data structure format;
transmitting the generated data between the first and second components; and
translating the generated data into the second native data structure format based on the exchanged native data structure format information.

39. The program product of claim 38 wherein exchanging includes sending first data structure format information from the first component to the second component and sending second data structure information from the second component to the first component.

40. The program product of claim 38 wherein the method further comprises generating a global ID for each of a plurality of variables included in the generated data.

41. The program product of claim 38 wherein the program product is an object-oriented program product.

42. The program product of claim 38 wherein the storage medium is a magnetic recording medium.

43. The program product of claim 38 wherein the storage medium is an optical recording medium.

44. The program product of claim 38 wherein the storage medium is a network distribution medium.

45. A method of processing data sent from a first component and received at a second component, the first and second components having first and second native data structure formats, respectively, comprising:
receiving first native data structure format information at the second component;
receiving the data in the first native data structure format to be processed at the second component; and
translating the received data into the second native data structure format based on the received first native data structure format information.

46. The method of claim 45 wherein the second component is a legacy component and the first component is an upgraded legacy component.

47. The method of claim 45 wherein the second component is a legacy version of an application and the first component is an upgraded version of the application.

48. A method of processing data to be transmitted from a first component to a second component, the first and second components having first and second native data structure formats, respectively, comprising:
generating first native data structure format information at the first component;
generating data in the first native data structure format and corresponding to the generated first native data structure format information;
transmitting the first native data structure format information to the second component; and
transmitting the generated data in the first native data structure format to the second component.

49. The method of claim 48 wherein the first native data structure format information is configured to assist the second component's translation of the data translated in the first native data structure format into the second native data structure format.

50. The method of claim 48 wherein the second component is a legacy component and the first component is an upgraded legacy component.

51. The method of claim 48 wherein the second component is a legacy version of an application and the first component is an upgraded version of the application.

52. The method of claim 48 further comprising establishing a communication link substantially immediately prior to transmitting the first native data structure format information and the generated data in the first native data structure format to the second component.

53. The method of claim 52 wherein the first native data structure format information is transmitted to the second component once per each establishment of the communication link, and the generated data in the first native data structure format includes a plurality of data messages each in the first native data structure format per each establishment of the communication link.
